(19) United States
(12) Patent Application Publication
(10) Pub. No.: US 2006/0177122 A1
(43) Pub. Date: Aug. 10, 2006

(54) Method and apparatus for particle manipulation using graphics processing

(75) Inventor: Masahiro Yasue, Kanagawa (JP)

Correspondence Address: KAPLAN GILMAN GIBSON & DERNIER L.L.P., 900 ROUTE 9 NORTH, WOODBRIDGE, NJ, 07095, US

(73) Assignee: Sony Computer Entertainment Inc.

(21) Appl. No.: 11/262,540

(22) Filed: Oct. 28, 2005

Related U.S. Application Data
(60) Provisional application No. 60/650,663, filed on Feb. 7, 2005.

(51) Int. Cl. G06K 9/00; G06T 15/00

(52) U.S. Cl. 382/154; 345/419

(57) ABSTRACT

Methods and apparatus are provided for: grouping objects within a three dimensional (3D) graphics space into a plurality of object sets, each object set being located in a respective sub-space within the 3D space; computing final graphics data for each object of the object sets based on initial graphics data for each of the objects, where the respective computations for each of the object sets are performed using a respective one of a plurality of processors of a multi-processor system; and repeating the above steps for each of a plurality of image frames using the final graphics data from a previous image frame as the initial graphics data for a current image frame.

### CROSS REFERENCE TO RELATED APPLICATION

This application claims the benefit of U.S. Provisional Patent Application No. 60/650,663, filed Feb. 7, 2005, entitled “Methods And Apparatus For Particle Manipulation Using Graphics Processing,” the entire disclosure of which is hereby incorporated by reference.

### BACKGROUND OF THE INVENTION

The present invention relates to a field of computer graphics and, in particular, to methods and apparatuses for processing large amounts of graphics data.

In recent years, there has been an insatiable desire for faster computer processing data throughputs because cutting-edge computer applications are becoming more and more complex, and are placing ever increasing demands on processing systems. Graphics applications are among those that place the highest demands on a processing system because they require such vast numbers of data accesses, data computations, and data manipulations in relatively short periods of time to achieve desirable visual results. Real-time, multimedia applications also place a high demand on processing systems; indeed, they require extremely fast processing speeds, such as many thousands of megabits of data per second.

For example, simulation of large pluralities of small objects (e.g., raindrops, snowflakes, bouncing balls, and the like) moving in a three-dimensional (3D) space involves, in each frame, the steps of defining changes in a spatial position of each object, performing 3D/2D transformation, polygonization, and rendering the objects for display on a display screen. In order to achieve satisfactory visual results, the graphics data is typically rendered at a frame rate of about 30 Hz (e.g., about 33 msec/frame) to appear to a human eye as a real-time, smooth movement. The vast number of calculations required for simulating such real-time moving objects places high demands on a computer processing system.

While some processing systems employ a single processor to achieve fast processing speeds, others are implemented utilizing multi-processor architectures. In multi-processor systems, a plurality of sub-processors can operate in parallel (or at least in concert) to achieve desired processing results. It has also been contemplated to employ a modular structure in a multi-processing system, where the computing modules are accessible over a broadband network (such as the Internet) and the computing modules may be shared among many users. Details regarding this modular structure may be found in U.S. Pat. No. 6,526,491, the entire disclosure of which is hereby incorporated by reference.

Some multi-processing systems employ a single instruction multiple data (SIMD) processing architecture to improve processing throughput. Even with a SIMD processing system, however, the real-time simulation of 106 or more objects may be inadequate.

Therefore, there are needs in the art for new methods and apparatus for processing graphics data that can process graphics data associated with very large numbers of graphics objects to achieve real-time simulation results.

### SUMMARY OF THE INVENTION

In accordance with one or more aspects of the present invention, the calculation of any changes in position of a plurality of objects in each frame are efficiently carried out, particularly when there are a significant number of objects in the space, such as 1 million or more. Even when a SIMD parallel processing environment is employed, aspects of the present invention permit the control of how the object data are allocated amongst the parallel processors and/or how the object data are stored in memory.

For example, the objects of a 3D space may be partitioned into a plurality of sub-spaces (or buckets), where each bucket contains some number of objects. In each frame, each of the parallel processors reads in the object data (initial position, velocity, force, color, etc.) for a particular bucket and performs both object movement and/or collision calculations (e.g., using Euler's equation) within that bucket. When each processor completes the calculations for a bucket, the data (e.g., final position, final velocity, color, etc.) are written back into memory and a next bucket is processed.

Preferably, each processor uses the “double buffer” technique to read and write data from/to the memory in order to hide DMA access latency between buckets. Further, the bucket size is preferably selected as a function of cycle time (frame rate), ready cycle/byte, write cycle/byte, calculation cycle/byte, and local storage memory size.

The particle data are preferably stored in system memory in an order that coincides with the particle position in the 3D space. For example, all of the particles in a particular bucket are stored in proximity to one another within the system memory. This improves the efficiency with which data transfers (such as DMA transfers) may be made between the system memory and the local memory of the processors. Further, when a SIMD architecture is employed, the types of object data (e.g., the position data, velocity data, force data, etc.) are preferably grouped in proximity to one another (or vectorized) to coincide with the SIMD capabilities of the processors. For example, if the processors may execute four units of data in one instruction, then four units of position data, four units of velocity data, and four units of force data, etc. are preferably stored in proximity to one another to improve SIMD processing speeds.

After the object data are manipulated, the data are preferably written into the system memory in locations as described above, which may require reorganization depending on the final position of the objects for the frame.

In accordance with one or more aspects of the present invention, methods and apparatus provide for: grouping objects within a three dimensional (3D) graphics space into a plurality of object sets, each object set being located in a respective sub-space within the 3D space; computing final graphics data for each object of the object sets based on initial graphics data for each of the objects, where the respective computations for each of the object sets are performed using a respective one of a plurality of processors of a multi-processor system; and repeating the above steps for each of a plurality of image frames using the final graphics data from a previous image frame as the initial graphics data for a current image frame.

The computation of final graphics data for a given object may include computing final position data for the object as a function of initial position data of the object and at least one of: an initial velocity of the object from the velocity data, an initial force on the object from the force data, and an initial mass of the object from the mass data. Alternatively or in addition, the computation of final graphics data for a given object may include computing whether the object collides with another object.

Preferably, grouping the objects into the object sets within the sub-spaces of the 3D space includes re-grouping at least some of the objects when the computation of final graphics data indicates that one or more objects have final position data falling outside their initial sub-spaces.

The methods and apparatus may further provide for: storing the final graphics data for the objects in a system memory that is operatively coupled to the plurality of processors; and grouping the final graphics data within the system memory in a manner that corresponds to the object sets and sub-spaces. Preferably, the final graphics data is re-grouped within the system memory when the computation of final graphics data indicates that one or more objects have final position data falling outside their initial sub-spaces.

In accordance with one or more further aspects of the present invention, the processors are operable to read/write data from/to the system memory in blocks, each block being a contiguous area in the system memory. For example, at least one of: (i) all of the position data are stored in a respective one or more contiguous blocks of memory; (ii) all of the force data are stored in a respective one or more contiguous blocks of memory; (iii) all of the velocity data are stored in a respective one or more contiguous blocks of memory; and (iv) all of the color data are stored in a respective one or more contiguous blocks of memory.

Alternatively, at least one of: all of the graphics data for a given object are stored in the same block of system memory; all the graphics data for a plurality of objects are stored in the same block or contiguous blocks of system memory; all the graphics data for a given object set are stored in the same block or contiguous blocks of system memory. Further, all of the graphics data for a given object may be stored sequentially within the same block of system memory.

Alternatively, the processors may be operable to perform single instruction multiple data (SIMD) computations, the number of multiple data computations being N; and at least some of the graphics data for respective sets of N objects are stored sequentially within the same block in system memory. Preferably, at least one of the position data, the force data, the velocity data, the color data, and the mass data for respective sets of N objects are stored sequentially within the same block in system memory.

The methods and apparatus preferably further provide for using the processors to read and process the graphics data for the object sets of the sub-spaces from system memory as the processors become available.

Other aspects, features, advantages, etc. will become apparent to one skilled in the art when the description of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a diagram illustrating a computer model used for simulating movement of objects in accordance with one or more embodiments of the present invention;

FIG. 2 is a flow diagram illustrating process steps for manipulating the objects of FIG. 1 in accordance with one or more embodiments of the present invention;

FIG. 3 is a block diagram illustrating the structure of a multi-processing system having two or more sub-processors capable of carrying out the process steps of FIG. 2;

FIG. 4 is a block diagram illustrating an alternative computer architecture employing SIMD technology in accordance with one or more aspects of the present invention;

FIG. 5 is a block diagram illustrating the structure of an exemplary sub-processing unit (SPU) of the system of FIG. 4 in accordance with one or more further embodiments of the present invention;

FIG. 6 is a block diagram illustrating the structure of a processing unit (PU) of the system of FIG. 4 in accordance with one or more further embodiments of the present invention;

FIG. 7 is a diagram illustrating how the graphics data may be organized in a system memory of the computer system of FIG. 3 and/or FIG. 4 in accordance with one or more embodiments of the present invention;

FIG. 8 is a diagram illustrating an alternative approach as to how the graphics data may be organized in the system memory of the computer system of FIG. 3 and/or FIG. 4 in accordance with one or more further embodiments of the present invention;

FIG. 9 is a diagram illustrating an further alternative approach as to how the graphics data may be organized in the system memory of the computer system of FIG. 3 and/or FIG. 4 in accordance with one or more further embodiments of the present invention; and

FIG. 10 is a timing diagram illustrating parallel processing of the graphics data using the computer system of FIG. 3 and/or FIG. 4 in accordance with one or more further embodiments of the present invention.

### DETAILED DESCRIPTION OF THE PRESENT INVENTION

The present invention advantageously provides methods and apparatus for processing graphics data (e.g., to achieve a computer simulation) associated with graphics objects, particularly large numbers of objects (e.g., about 10⁶ or more). By way of example, such objects may be raindrops, snowflakes and the like, which may number in the thousands, hundreds of thousands, millions and more, depending on the particular simulation and 3D space in which the objects are disposed. Herein, these and similar moving objects may be referred to as particles.

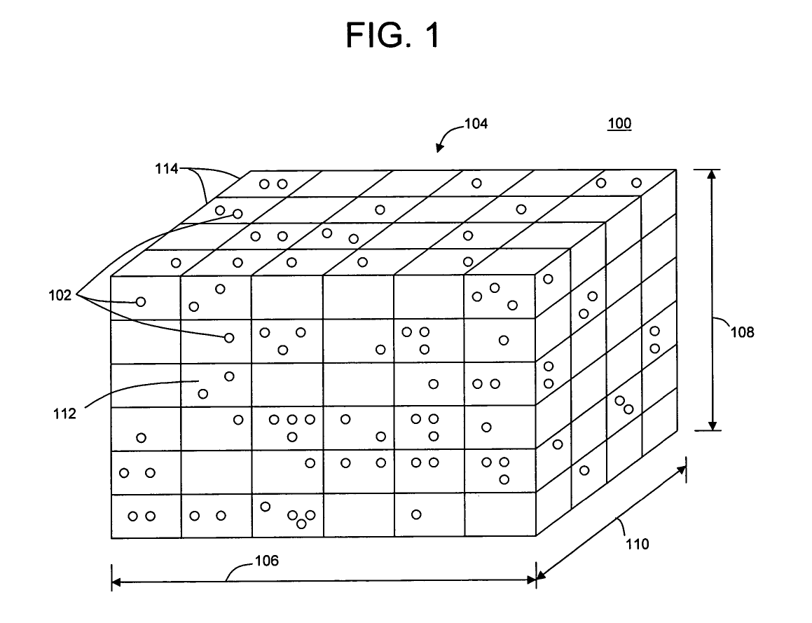

FIG. 1 is a diagram 100 illustrating a computer model used for simulating moving objects 102 in a 3D space 104 in accordance with one or more embodiments of the present invention. The 3D space 104 illustratively has a width 106, a height 108, and a depth 110 and is partitioned in a pluraly of N individual sub-spaces, or buckets, 112. In the depicted embodiment, the 3D space 104 illustratively comprises four panes 114, each such pane having 36 buckets 112, and all buckets have the same dimensions. In alternate embodiments, the 3D space 104 may comprise any number of panes having any number of buckets. Further the dimensions of the buckets 112 may vary depending on the specific application.

In accordance with one or more exemplary embodiments, at an arbitrary moment of time, each object 102 may be defined as having a mass (or weight) M, specific dimensions, a color attribute L (RGB, α), a velocity V(x, y, z), a force F(x, y, z) acting thereon, and/or a spatial position P(x, y, z). Herein x, y, and z are rectangular Cartesian coordinates, the abbreviation RGB conventionally relates to a standard (Red/Green/Blue) color scheme, and α is an intensity of the visual image of the object 102. It is understood that other coordinate systems may be employed and other color conventions may be employed without departing from the spirit and scope of the invention.

In the depicted embodiment, the objects 102 illustratively have the same mass, and dimensions. However, in further embodiments (not shown), such limitations may be removed, in part or entirely. For example, individual properties (e.g., a size or a mass) may be assigned to at least a portion of a given object 102. Further, the objects 102 may selectively be associated with other properties, such as time, surface hardness, and the like. Accordingly, more computing resources and larger memory may be required to for simulating objects having such properties.

In accordance with one or more aspects of the present invention, final graphics data for each object 102 in the 3D space 104 is computed based on initial graphics data for each of the objects 104. Such computation is preferably performed on a frame-by-frame basis such that the graphics data may be rendered and displayed to provide the appearance of real-time movement of the objects 102 within the space 104. In many applications, the duration of a frame is preferably about 1/30 sec. In a frame, each bucket 112 may comprise any portion of a total number of the objects 102 concurrently residing in the 3D space 104. Accordingly, in consecutive frames, a bucket 112 may comprise either the same or a different number of the objects 102, since some objects 102 can move into or out of any of the buckets 112.

In accordance with one or more further aspects of the present invention, the computed movement of the objects 102 in the 3D space 104 may result in one or more collisions between objects 102 and/or with one or more other objects (not shown) such as walls, barriers, and other obstacles that may optionally be disposed in the space 104. The collisions may be of an elastic type or non-elastic type. In the art, such types of collisions have known analytical models (e.g., based on the Euler's equations or similar formulas) for describing the post-collision trajectories of the objects 102. Alternatively, the collisions may follow custom (i.e., specific) laws of interactions that are selectively imposed on the intersecting objects 102.

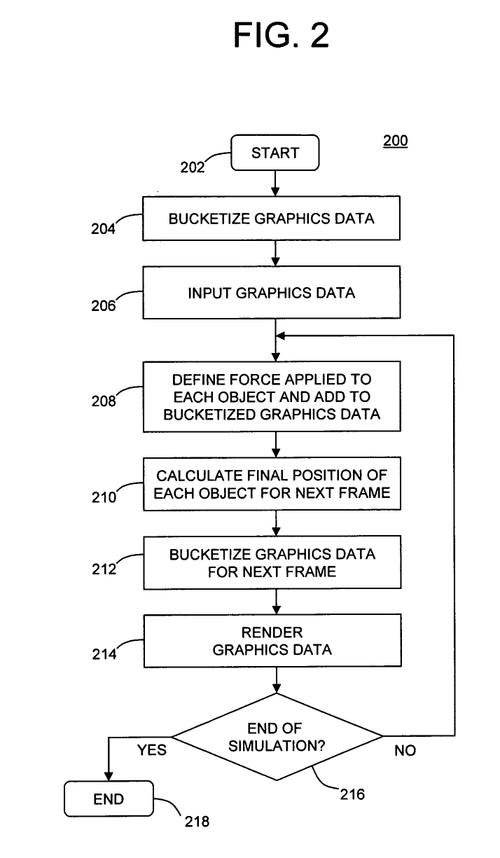

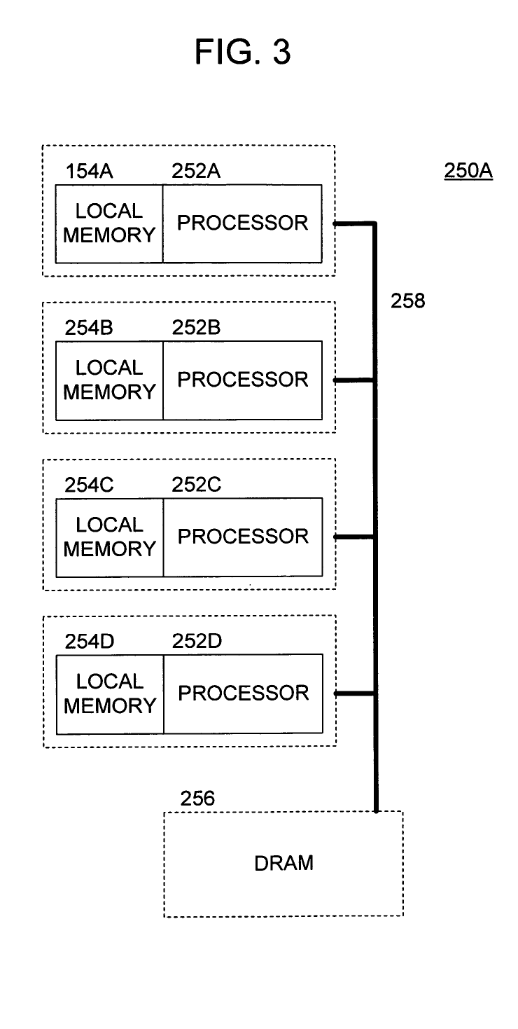

FIG. 2 is a flow diagram illustrating a method 200 of processing the graphics data in accordance with one of more embodiments of the present invention. FIG. 3 is a diagram illustrating the structure of a multi-processing system 250 having two or more sub-processors 252 and a system memory 256 that are capable of executing one or more portions of the method 200. Each of the processors 252A-D preferably includes an associated local memory 254A-D, and is coupled to the main (system) memory 256 by way of a bus 258. Although four processors 252 are illustrated by way of example, any number may be utilized without departing from the spirit and scope of the present invention. The processors 252 may be implemented with any of the known technologies, and each processor 252 may be of similar construction or of differing construction.

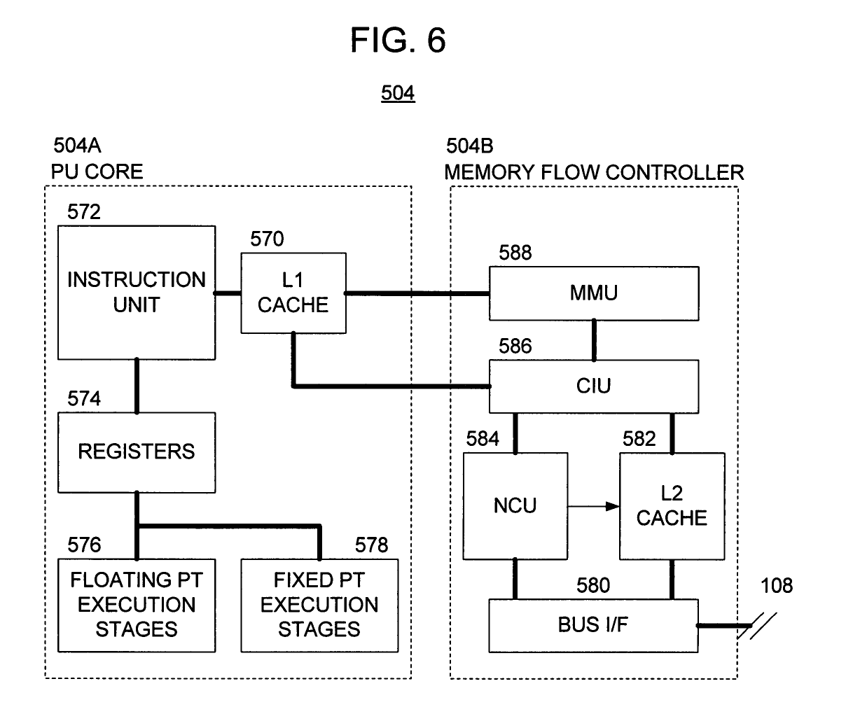

The method 200 starts (step 202) and proceeds to step 204, where the graphics data of the objects 102 are grouped (organized, or bucketized) within the 3D graphics space 104 into a plurality of object sets, each object set being located in a respective sub-space (or bucket) 112 within the 3D space 104. The graphics data are also stored in the system memory 256 such that the graphics data corresponding to the objects 102 residing in the same bucket 112 are located in proximity to one another in the system memory 256. Exemplary methods of organizing and storing the graphics data for the objects 102 in the system memory 256 will be discussed in more detail later in this description with reference to FIGS. 6-8. For now, it suffices to say that it is preferred that similar types of the graphics data (e.g., the position data P(x, y, z), the velocity data V(x, y, z), the color attribute data L(RGB, α), and the like) are grouped and stored in proximity to one another to allow for best utilization of the computing capabilities (e.g., data processing speeds) of the sub-processing units 252 of the computer system 250.

At step 206, the graphics data relating to an initial state of the objects 102 is entered. This may involve reading the graphics data from the system memory 256 to one or more of the local memories 254 of the processors 252. By way of example, the graphics data may include initial position data P(x, y, z), initial velocity data V(x, y, z), and initial color attribute data L(RGB, α) for each object 102 in the 3D space 104.

At step 208, the respective initial force F(x, y, z) applied to the objects 102 is defined at the initial positions P(x, y, z) of the objects 102 in the 3D space 104. The initial force data are grouped with the remaining graphics data so as to adhere to the computing technique employed by the sub-processors 252. For example, as will be discussed later in this description, if the sub-processors 252 employ SIMD technology certain groupings of the graphics data may yield superior results.

At step 210, the sub-processors 252 compute final graphics data for each object 102 of the object sets based on the initial graphics data. For example, the final positions P(x, y, z) of the objects 102 moving in the field of the force F(x, y, z) are computed in the given frame. More particularly, the final position data for the objects 102 may be computed as a function of the initial position data of the objects 102 and at least one of: the initial velocities of the objects 102, the force data for the objects 102, and the initial masses of the objects 102. This computation may involve applying analytical modeling schemes to calculate the final positions, final velocities, final colors, final masses, etc. of the objects 102 in the 3D space 104. The computation may also involve determining whether one or more of the objects 102 collide with other objects 102 or other obstacles in the 3D space 104.

It is most preferred that the respective computations for each of the object sets are performed using a respective one of the sub-processors 252 of the multi-processor system 250. Indeed, it is preferred that a given sub-processor 252 compute all movements and/or collisions (final graphics data) for a given sub-space 112 without consideration of the objects 102 in adjacent sub-spaces 112. This assumption as to the real-time movement of all the objects 102 in the 3D space leads to significant computational and throughput efficiencies. When a given sub-processor 252 has completed the computations of the final graphics data for a given object set (for the given frame), the sub-processor 252 is free to dynamically obtain another object set for computation.

As a result of the computed movements in the frame, some objects 102 may move to locations outside the buckets 112 in which their initial position was located, i.e., the objects may move to other buckets 112. Furthermore, some objects 102 may leave the 3D space 104 entirely and, as such, may be excluded from further simulations. Since movements and/or collisions (final graphics data) are computed for a given sub-space 112 without consideration of the objects 102 in adjacent sub-spaces 112, significant reductions in computational complexity are achieved. Indeed, within a given sub-space, no consideration need be given as to an object entering that sub-space 112 from another sub-space 112. Thus, a number of potential collisions associated with an object entering the sub-space 112 from another sub-space 112 need not be computed. This can significantly reduce computations.

At step 212, some of all of the objects 102 are re-grouped into one or more new object sets when the computation of the final graphics data indicates that one or more objects 102 have final position data falling outside their initial sub-spaces 112. Preferably, such re-grouping triggers a re-organization of the graphics data in the system memory 256 in a manner substantially similar to that described above with reference to step 204.

At step 214, at least some of the final graphics data is used to render the objects for display on a video display (e.g., a thin film transistor (TFT) display, plasma display, a cathode tube display (CRT), a cinema screen, and the like). This may include 3D/2D data conversion and polygonization of the final position data for the objects 102.

The actions associated with steps 208-214 are preferably repeated on a frame-by-frame basis at a sufficient rate to simulate the real-time movement of the objects 102 within the 3D space 104. In this regard, it is understood that the final graphics data from a previous frame is used as the initial graphics data for the current frame. Thus, at decision step 216, the method 200 queries if the final graphics data has been rendered for all frames or, alternatively, for a pre-determined time interval. If the result of the determination of step 216 is in the negative, the process flow loops back to step 208. If the result of the determination of step 216 is in the affirmative, the process flow advances to step 218 where the process ends.

A description of a preferred computer architecture for a multi-processor system will now be provided that is suitable for carrying out one or more of the features discussed herein. In accordance with one or more embodiments, the multi-processor system may be implemented as a single-chip solution operable for stand-alone and/or distributed processing of media-rich applications, such as game systems, home terminals, PC systems, server systems and workstations. In some applications, such as game systems and home terminals, real-time computing may be a necessity. For example, in a real-time, distributed gaming application, one or more of networking image decompression, 3D computer graphics, audio generation, network communications, physical simulation, and artificial intelligence processes have to be executed quickly enough to provide the user with the illusion of a real-time experience. Thus, each processor in the multi-processor system must complete tasks in a short and predictable time.

To this end, and in accordance with this computer architecture, all processors of a multi-processing computer system are constructed from a common computing module (or cell). This common computing module has a consistent structure and preferably employs the same instruction set architecture. The multi-processing computer system can be formed of one or more clients, servers, PCs, mobile computers, game machines, PDAs, set top boxes, appliances, digital televisions and other devices using computer processors.

A plurality of the computer systems may also be members of a network if desired. The consistent modular structure enables efficient, high speed processing of applications and data by the multi-processing computer system, and if a network is employed, the rapid transmission of applications and data over the network. This structure also simplifies the building of members of the network of various sizes and processing power and the preparation of applications for processing by these members.

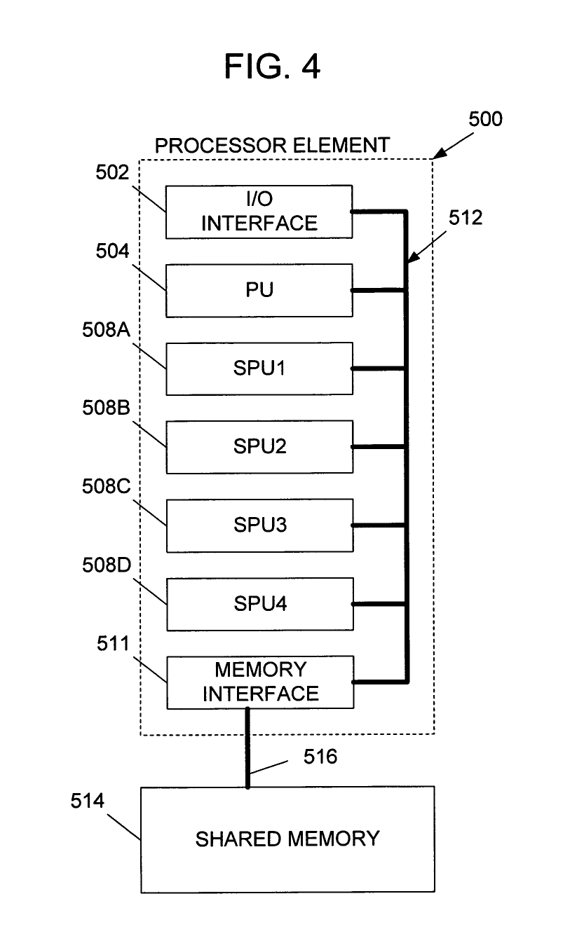

With reference to FIG. 4, the basic processing module is a processor element (PE) 500. The PE 500 comprises an I/O interface 502, a processing unit (PU) 504, and a plurality of sub-processing units 508, namely, sub-processing unit 508A, sub-processing unit 508B, sub-processing unit 508C, and sub-processing unit 508D. A local (or internal) PE bus 512 transmits data and applications among the PU 504, the sub-processing units 508, and a memory interface 511. The local PE bus 512 can have, e.g., a conventional architecture or can be implemented as a packet-switched network. If implemented as a packet switch network, while requiring more hardware, increases the available bandwidth.

The PE 500 can be constructed using various methods for implementing digital logic. The PE 500 preferably is constructed, however, as a single integrated circuit employing a complementary metal oxide semiconductor (CMOS) on a silicon substrate. Alternative materials for substrates include gallium arsinide, gallium aluminum arsinide and other so-called III-B compounds employing a wide variety of dopants. The PE 500 also may be implemented using superconducting material, e.g., rapid single-flux-quantum (RSFQ) logic.

The PE 500 is closely associated with a shared (main) memory 514 through a high bandwidth memory connection 516. Although the memory 514 preferably is a dynamic random access memory (DRAM), the memory 514 could be implemented using other means, e.g., as a static random access memory (SRAM), a magnetic random access memory (MRAM), an optical memory, a holographic memory, etc.

The PU 504 and the sub-processing units 508 are preferably each coupled to a memory flow controller (MFC) including direct memory access DMA functionality, which in combination with the memory interface 511, facilitate the transfer of data between the DRAM 514 and the sub-processing units 508 and the PU 504 of the PE 500. It is noted that the DMAC and/or the memory interface 511 may be integrally or separately disposed with respect to the sub-processing units 508 and the PU 504. Indeed, the DMAC function and/or the memory interface 511 function may be integral with one or more (preferably all) of the sub-processing units 508 and the PU 504. It is also noted that the DRAM 514 may be integrally or separately disposed with respect to the PE 500. For example, the DRAM 514 may be disposed off-chip as is implied by the illustration shown or the DRAM 514 may be disposed on-chip in an integrated fashion.

The PU 504 can be, e.g., a standard processor capable of stand-alone processing of data and applications. In operation, the PU 504 preferably schedules and orchestrates the processing of data and applications by the sub-processing units. The sub-processing units preferably are single instruction, multiple data (SIMD) processors. Under the control of the PU 504, the sub-processing units perform the processing of these data and applications in a parallel and independent manner. The PU 504 is preferably implemented using a PowerPC core, which is a microprocessor architecture that employs reduced instruction-set computing (RISC) technique. RISC performs more complex instructions using combinations of simple instructions. Thus, the timing for the processor may be based on simpler and faster operations, enabling the microprocessor to perform more instructions for a given clock speed.

It is noted that the PU 504 may be implemented by one of the sub-processing units 508 taking on the role of a main processing unit that schedules and orchestrates the processing of data and applications by the sub-processing units 508. Further, there may be more than one PU implemented within the processor element 500.

In accordance with this modular structure, the number of PEs 500 employed by a particular computer system is based upon the processing power required by that system. For example, a server may employ four PEs 500, a workstation may employ two PEs 500 and a PDA may employ one PE 500. The number of sub-processing units of a PE 500 assigned to processing a particular software cell depends upon the complexity and magnitude of the programs and data within the cell.

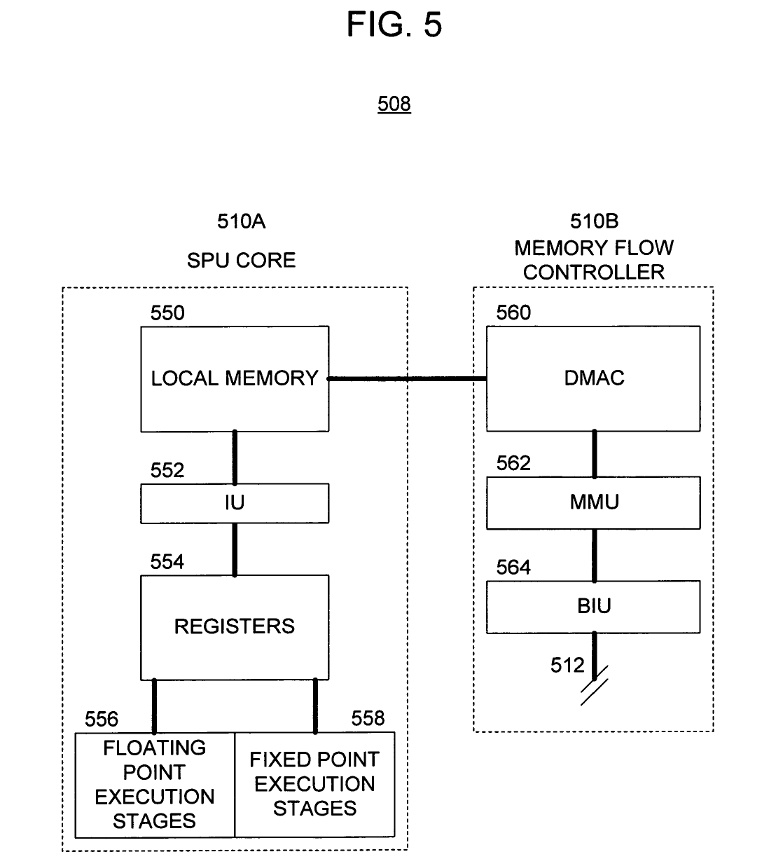

FIG. 5 illustrates the preferred structure and function of a sub-processing unit (SPU) 508. The SPU 508 architecture preferably fills a void between general-purpose processors (which are designed to achieve high average performance on a broad set of applications) and special-purpose processors (which are designed to achieve high performance on a single application). The SPU 508 is designed to achieve high performance on game applications, media applications, broadband systems, etc., and to provide a high degree of control to programmers of real-time applications. Some capabilities of the SPU 508 include graphics geometry pipelines, surface subdivision, Fast Fourier Transforms, image processing keywords, stream processing, MPEG encoding/decoding, encryption, decryption, device driver extensions, modeling, game physics, content creation, and audio synthesis and processing.

The sub-processing unit 508 includes two basic functional units, namely an SPU core 510A and a memory flow controller (MFC) 510B. The SPU core 510A performs program execution, data manipulation, etc., while the MFC 510B performs functions related to data transfers between the SPU core 510A and the DRAM 514 of the system.

The SPU core 510A includes a local memory 550, an instruction unit (IU) 552, registers 554, one ore more floating point execution stages 556 and one or more fixed point execution stages 558. The local memory 550 is preferably implemented using single-ported random access memory, such as an SRAM. Whereas most processors reduce latency to memory by employing caches, the SPU core 510A implements the relatively small local memory 550 rather than a cache. Indeed, in order to provide consistent and predictable memory access latency for programmers of real-time applications (and other applications as mentioned herein) a cache memory architecture within the SPU 508A is not preferred. The cache hit/miss characteristics of a cache memory results in volatile memory access times, varying from a few cycles to a few hundred cycles. Such volatility undercuts the access timing predictability that is desirable in, for example, real-time application programming. Latency hiding may be achieved in the local memory SRAM 550 by overlapping DMA transfers with data computation. This provides a high degree of control for the programming of real-time applications. As the latency and instruction overhead associated with DMA transfers exceeds that of the latency of servicing a cache miss, the SRAM local memory approach achieves an advantage when the DMA transfer size is sufficiently large and is sufficiently predictable (e.g., a DMA command can be issued before data is needed).

A program running on a given one of the sub-processing units 508 references the associated local memory 550 using a local address, however, each location of the local memory 550 is also assigned a real address (RA) within the overall system's memory map. This allows Privilege Software to map a local memory 550 into the Effective Address (EA) of a process to facilitate DMA transfers between one local memory 550 and another local memory 550. The PU 504 can also directly access the local memory 550 using an effective address. In a preferred embodiment, the local memory 550 contains 556 kilobytes of storage, and the capacity of registers 552 is 128×128 bits.

The SPU core 504A is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the IU 552 includes an instruction buffer, instruction decode circuitry, dependency check circuitry, and instruction issue circuitry.

The instruction buffer preferably includes a plurality of registers that are coupled to the local memory 550 and operable to temporarily store instructions as they are fetched. The instruction buffer preferably operates such that all the instructions leave the registers as a group, i.e., substantially simultaneously. Although the instruction buffer may be of any size, it is preferred that it is of a size not larger than about two or three registers.

In general, the decode circuitry breaks down the instructions and generates logical micro-operations that perform the function of the corresponding instruction. For example, the logical micro-operations may specify arithmetic and logical operations, load and store operations to the local memory 550, register source operands and/or immediate data operands. The decode circuitry may also indicate which resources the instruction uses, such as target register addresses, structural resources, function units and/or busses. The decode circuitry may also supply information indicating the instruction pipeline stages in which the resources are required. The instruction decode circuitry is preferably operable to substantially simultaneously decode a number of instructions equal to the number of registers of the instruction buffer.

The dependency check circuitry includes digital logic that performs testing to determine whether the operands of given instruction are dependent on the operands of other instructions in the pipeline. If so, then the given instruction should not be executed until such other operands are updated (e.g., by permitting the other instructions to complete execution). It is preferred that the dependency check circuitry determines dependencies of multiple instructions dispatched from the decoder circuitry 112 simultaneously.

The instruction issue circuitry is operable to issue the instructions to the floating point execution stages 556 and/or the fixed point execution stages 558.

The registers 554 are preferably implemented as a relatively large unified register file, such as a 128-entry register file. This allows for deeply pipelined high-frequency implementations without requiring register renaming to avoid register starvation. Renaming hardware typically consumes a significant fraction of the area and power in a processing system. Consequently, advantageous operation may be achieved when latencies are covered by software loop unrolling or other interleaving techniques.

Preferably, the SPU core 510A is of a superscalar architecture, such that more than one instruction is issued per clock cycle. The SPU core 510A preferably operates as a superscalar to a degree corresponding to the number of simultaneous instruction dispatches from the instruction buffer, such as between 2 and 3 (meaning that two or three instructions are issued each clock cycle). Depending upon the required processing power, a greater or lesser number of floating point execution stages 556 and fixed point execution stages 558 may be employed. In a preferred embodiment, the floating point execution stages 556 operate at a speed of 32 billion floating point operations per second (32 GFLOPS), and the fixed point execution stages 558 operate at a speed of 32 billion operations per second (32 GOPS).

The MFC 510B preferably includes a bus interface unit (BIU) 564, a memory management unit (MMU) 562, and a direct memory access controller (DMAC) 560. With the exception of the DMAC 560, the MFC 510B preferably runs at half frequency (half speed) as compared with the SPU core 510A and the bus 512 to meet low power dissipation design objectives. The MFC 510B is operable to handle data and instructions coming into the SPU 508 from the bus 512, provides address translation for the DMAC, and snoop-operations for data coherency. The BIU 564 provides an interface between the bus 512 and the MMU 562 and DMAC 560. Thus, the SPU 508 (including the SPU core 510A and the MFC 510B) and the DMAC 560 are connected physically and/or logically to the bus 512.

The MMU 562 is preferably operable to translate effective addresses (taken from DMA commands) into real addresses for memory access. For example, the MMU 562 may translate the higher order bits of the effective address into real address bits. The lower-order address bits, however, are preferably untranslatable and are considered both logical and physical for use to form the real address and request access to memory. In one or more embodiments, the MMU 562 may be implemented based on a 64-bit memory management model, and may provide 2⁶⁴ bytes of effective address space with 4K-, 64K-, 1M-, and 16M-byte page sizes and 256MB segment sizes. Preferably, the MMU 562 is operable to support up to 2⁶⁵ bytes of virtual memory, and 2⁴² bytes (4 TeraBytes) of physical memory for DMA commands. The hardware of the MMU 562 may include an 8-entry, fully associative SLB, a 256-entry, 4way set associative TLB, and a 4×4 Replacement Management Table (RMT) for the TLB—used for hardware TLB miss handling.

The DMAC 560 is preferably operable to manage DMA commands from the SPU core 510A and one or more other devices such as the PU 504 and/or the other SPUs. There may be three categories of DMA commands: Put commands, which operate to move data from the local memory 550 to the shared memory 514; Get commands, which operate to move data into the local memory 550 from the shared memory 514; and Storage Control commands, which include SLI commands and synchronization commands. The synchronization commands may include atomic commands, send signal commands, and dedicated barrier commands. In response to DMA commands, the MMU 562 translates the effective address into a real address and the real address is forwarded to the BIU 564.

The SPU core 510A preferably uses a channel interface and data interface to communicate (send DMA commands, status, etc.) with an interface within the DMAC 560. The SPU core 510A dispatches DMA commands through the channel interface to a DMA queue in the DMAC 560. Once a DMA command is in the DMA queue, it is handled by issue and completion logic within the DMAC 560. When all bus transactions for a DMA command are finished, a completion signal is sent back to the SPU core 510A over the channel interface.

FIG. 6 illustrates the preferred structure and function of the PU 504. The PU 504 includes two basic functional units, the PU core 504A and the memory flow controller (MFC) 504B. The PU core 504A performs program execution, data manipulation, multi-processor management functions, etc., while the MFC 504B performs functions related to data transfers between the PU core 504A and the memory space of the system 100.

The PU core 504A may include an L1 cache 570, an instruction unit 572, registers 574, one or more floating point execution stages 576 and one or more fixed point execution stages 578. The L1 cache provides data caching functionality for data received from the shared memory 106, the processors 102, or other portions of the memory space through the MFC 504B. As the PU core 504A is preferably implemented as a superpipeline, the instruction unit 572 is preferably implemented as an instruction pipeline with many stages, including fetching, decoding, dependency checking, issuing, etc. The PU core 504A is also preferably of a superscalar configuration, whereby more than one instruction is issued from the instruction unit 572 per clock cycle. To achieve a high processing power, the floating point execution stages 576 and the fixed point execution stages 578 include a plurality of stages in a pipeline configuration. Depending upon the required processing power, a greater or lesser number of floating point execution stages 576 and fixed point execution stages 578 may be employed.

The MFC 504B includes a bus interface unit (BIU) 580, an L2 cache memory, a non-cachable unit (NCU) 584, a core interface unit (CIU) 586, and a memory management unit (MMU) 588. Most of the MFC 504B runs at half frequency (half speed) as compared with the PU core 504A and the bus 108 to meet low power dissipation design objectives.

The BIU 580 provides an interface between the bus 108 and the L2 cache 582 and NCU 584 logic blocks. To this end, the BIU 580 may act as a Master as well as a Slave device on the bus 108 in order to perform fully coherent memory operations. As a Master device it may source load/store requests to the bus 108 for service on behalf of the L2 cache 582 and the NCU 584. The BIU 580 may also implement a flow control mechanism for commands which limits the total number of commands that can be sent to the bus 108. The data operations on the bus 108 may be designed to take eight beats and, therefore, the BIU 580 is preferably designed around 128 byte cache-lines and the coherency and synchronization granularity is 128 KB.

The L2 cache memory 582 (and supporting hardware logic) is preferably designed to cache 512 KB of data. For example, the L2 cache 582 may handle cacheable loads/stores, data pre-fetches, instruction fetches, instruction pre-fetches, cache operations, and barrier operations. The L2 cache 582 is preferably an 8-way set associative system. The L2 cache 582 may include six reload queues matching six (6) castout queues (e.g., six RC machines), and eight (64-byte wide) store queues. The L2 cache 582 may operate to provide a backup copy of some or all of the data in the L1 cache 570. Advantageously, this is useful in restoring state(s) when processing nodes are hot-swapped. This configuration also permits the L1 cache 570 to operate more quickly with fewer ports, and permits faster cache-to-cache transfers (because the requests may stop at the L2 cache 582). This configuration also provides a mechanism for passing cache coherency management to the L2 cache memory 582.

The NCU 584 interfaces with the CIU 586, the L2 cache memory 582, and the BIU 580 and generally functions as a queueing/buffering circuit for non-cacheable operations between the PU core 504A and the memory system. The NCU 584 preferably handles all communications with the PU core 504A that are not handled by the L2 cache 582, such as cache-inhibited load/stores, barrier operations, and cache coherency operations. The NCU 584 is preferably run at half speed to meet the aforementioned power dissipation objectives.

The CIU 586 is disposed on the boundary of the MFC 504B and the PU core 504A and acts as a routing, arbitration, and flow control point for requests coming from the execution stages 576, 578, the instruction unit 572, and the MMU unit 588 and going to the L2 cache 582 and the NCU 584. The PU core 504A and the MMU 588 preferably run at full speed, while the L2 cache 582 and the NCU 584 are operable for a 2:1 speed ratio. Thus, a frequency boundary exists in the CIU 586 and one of its functions is to properly handle the frequency crossing as it forwards requests and reloads data between the two frequency domains.

The CIU 586 is comprised of three functional blocks: a load unit, a store unit, and reload unit. In addition, a data pre-fetch function is performed by the CIU 586 and is preferably a functional part of the load unit. The CIU 586 is preferably operable to: (i) accept load and store requests from the PU core 504A and the MMU 588; (ii) convert the requests from full speed clock frequency to half speed (a 2:1 clock frequency conversion); (iii) route cachable requests to the L2 cache 582, and route non-cachable requests to the NCU 584; (iv) arbitrate fairly between the requests to the L2 cache 582 and the NCU 584; (v) provide flow control over the dispatch to the L2 cache 582 and the NCU 584 so that the requests are received in a target window and overflow is avoided; (vi) accept load return data and route it to the execution stages 576, 578, the instruction unit 572, or the MMU 588; (vii) pass snoop requests to the execution stages 576, 578, the instruction unit 572, or the MMU 588; and (viii) convert load return data and snoop traffic from half speed to full speed.

The MMU 588 preferably provides address translation for the PU core 540A, such as by way of a second level address translation facility. A first level of translation is preferably provided in the PU core 504A by separate instruction and data ERAT (effective to real address translation) arrays that may be much smaller and faster than the MMU 588.

In a preferred embodiment, the PU 504 operates at 4-6 GHz, 10F04, with a 64-bit implementation. The registers are preferably 64 bits long (although one or more special purpose registers may be smaller) and effective addresses are 64 bits long. The instruction unit 570, registers 572 and execution stages 574 and 576 are preferably implemented using PowerPC technology to achieve the (RISC) computing technique.

Additional details regarding the modular structure of this computer system may be found in U.S. Pat. No. 6,526,491, the entire disclosure of which is hereby incorporated by reference.

As noted above, the PE 500 of FIG. 4 may carry out the method 200 as discussed in detail hereinabove with respect to FIG. 2. It is noted that in order to hide access latency of the DMAC 506 and, as such, increase data processing speeds during repetitive memory operations (e.g., reading and writing the data from/to the system memory 514 or local memories 550), the sub-processing units 508 may also use the well known “double buffer” technique.

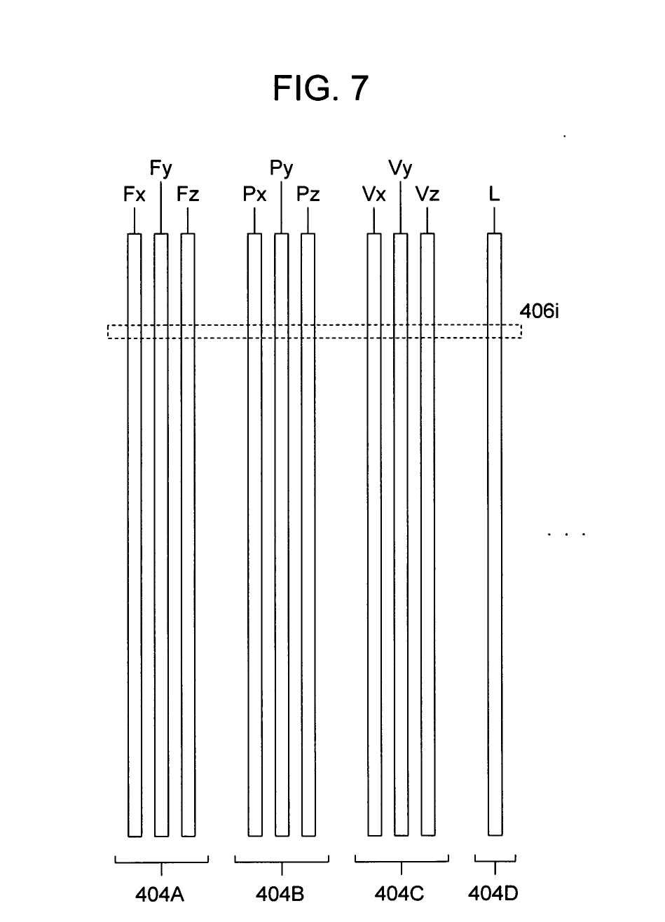

Reference is now made to FIGS. 7-9 which illustrate different ways of organizing the graphics data in the system memory of the computer system of FIG. 3 and/or FIG. 4 in accordance with one or more embodiments of the present invention. For purposes of clarity and brevity, the description of FIGS. 7-9 will be made with reference to PE 500 and the system memory 514 of FIG. 4. In particular, the processors 508 are operable to read/write data from/to the system memory 514 in blocks, each block being a contiguous area in the system memory 514. This technique is described in detail in U.S. Pat. No. 6,526,491.

As illustrated in FIG. 7, the memory 514 may include a number of areas 404i, each having one or more contiguous blocks. In this embodiment of the invention, all of the force data F(x, y, z) are stored in a first area 404A comprising one or more contiguous blocks of memory. All of the position data P(x, y, z) are stored in a second area 404B comprising one or more contiguous blocks of memory. All of the velocity data V(x, y, z) are stored in a third area 404C comprising one or more contiguous blocks of memory. And all of the color data L are stored in a fourth area 404D comprising one or more contiguous blocks of memory. The graphics data for each of the respective objects 102, may be located by traversing the areas 404i, for example, as illustrated by reference numeral 406i. As discussed above, it is desirable to locate the graphics data for the objects 102 within a given object set or sub-space 112 near one another in the memory 514. As illustrated in FIG. 7, such proximity may be realized by disposing the graphics data for the object sets in more than one area 404.

With this arrangement, the memory 514 is efficiently used because the number of unused memory locations in each of the areas 404i may be minimized and/or eliminated. Further, the speed at which the processors 508 may obtain the graphics data is relatively fast because there is alignment of the graphics data by object 102 and by object set even though the data are disposed in different blocks. In order realize these benefits, however, the application program effecting the data organization in the memory 514 must reorganize the graphics data in all memory areas 404i when the objects 102 move into or out of sub-spaces 112.

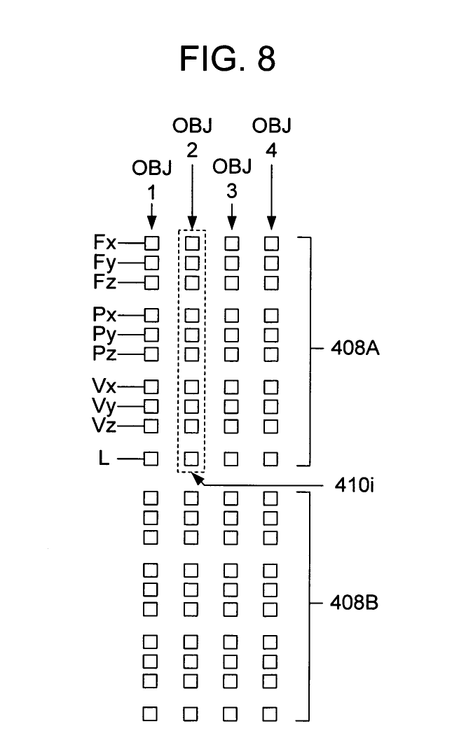

As illustrated in FIG. 8, the memory 514 may include a number of areas 408, where each area may include one or more contiguous blocks. In this embodiment of the invention, all of the graphics data (e.g., F, P, V, L) for a given object 102 are stored in the same area or block of the system memory 514. All of the graphics data for a given object are stored sequentially as illustrated by reference numeral 410i. Again, it is desirable to locate the graphics data for the objects 102 within a given object set or sub-space 112 near one another in the memory 514. As illustrated in FIG. 8, such proximity may be realized by disposing the graphics data for the object sets in the same area 404 in memory 514.

With this arrangement, the memory 514 is believed to be less efficiently used as compared with the arrangement of FIG. 7 because a number of unused memory locations are needed in each of the areas 408 to ensure proper alignment. In some multi-processing environments, such as when SIMD processors 508 are employed, the speed at which the processors 508 may obtain and process the graphics data is reduced because the data types (e.g., Fx, Fy, Fz, Px, Py, Pz, Vx, Vy, Vz, etc.) must be vectorized such that respective sets of the data may be operated upon using a single instruction. The application program effecting the data organization in the memory 514 can reorganize the graphics data in all memory areas 408 relatively easily because all the graphics data for a given object 102 may be found in the same block.

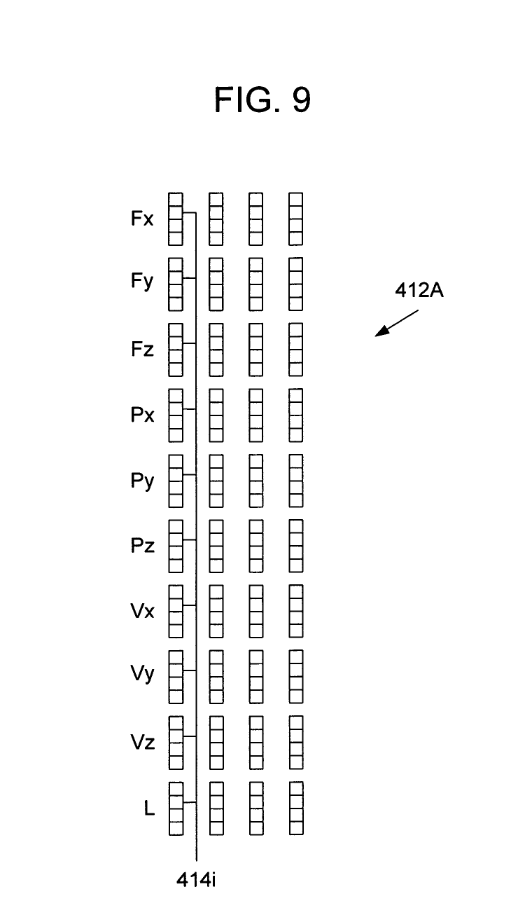

As illustrated in FIG. 9, the memory 514 may include a number of areas 412, where each area 412 may include one or more contiguous blocks. In this embodiment of the invention, all of the graphics data (e.g., F, P, V, L) for a given object 102 are stored in the same area 412 or block of the system memory 514. The graphics data are preferably vectorized by sequentially storing the data for N objects in the block. For example, if N is four, four Fx components of the force data, four Fy components of the force data and four Fz components of the force data are stored sequentially. Similar sequential groupings are made for the position data P, the velocity data V, the color data L, etc. Thus, the graphics data for a given object 102 is scattered to some degree within the block of memory as indicated by reference numeral 414i. Advantageously, this arrangement increases the speed at which the data are processed when SIMD processors 508 are employed. This is so because the data types (e.g., Fx, Fy, Fz, Px, Py, Pz, Vx, Vy, Vz, etc.) are already vectorized in the memory 514 and may be operated upon using a single SIMD instruction.

With this arrangement, however, the memory 514 is believed to be less efficiently used as compared with the arrangement of FIG. 7 because a number of unused memory locations are needed in each of the areas 412 to ensure proper alignment and vectorization. The application program effecting the data organization in the memory 514 will likely be complex in order to reorganize the graphics data in all memory areas 412 when the objects 102 move into or out of sub-spaces 112.

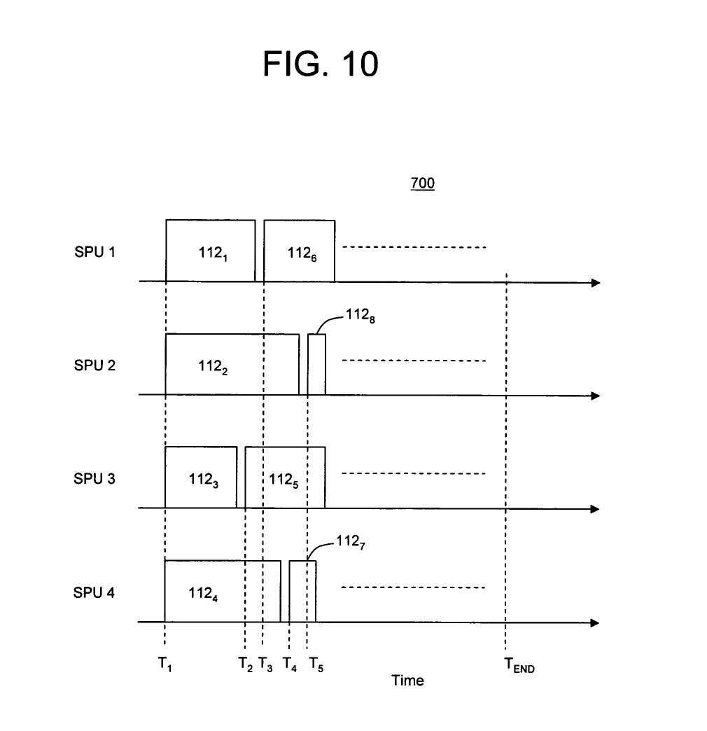

Reference is now made to FIG. 10, which is a timing diagram 700 illustrating how the graphics data for the given sub-spaces 112 are processed in the processors, such as the processors SPUL, SPU2, SPU3, and SPU4 (508A-D) of FIG. 4, during each frame. It is noted that the assignment of a given sub-space 112 of objects 102 to a particular SPU 508 is preferably based on whether the SPU is available to process all of the objects of a given sub-space 112. Further, this assignment may be managed by the PU 504 or it may be managed by the SPUs 508 themselves.

At time T₁, all the SPUs 508 are assumed to be available to process object sets and, thus, each SPU 508 obtains the graphics data for a given sub-space 112. For example, SPU1-SPU4 obtain the graphics data for sub-spaces 112₁-112₄, respectively. The duration of time needed by a given SPU to process the graphics data of a given object set is generally proportional to the number of objects 102 in the sub-space 112. Thus, each of SPU1-SPU4 may complete such processing at different times. In an extreme case, a given sub-space 112 may contain no objects 102 and, therefore, may be quickly dispatched and/or ignored altogether, at least for the given time interval.

When SPU3 completes the calculations for the objects 102 of the sub-space 112₃, at about time T₂, SPU3 obtains the graphics data for another sub-space, such as sub-space 112₅. Similarly, at about time T₃, SPU1 may complete the processing of sub-space 112₁ and obtain the graphics data for the objects 102 of sub-space 112₆ and begin processing such data. At about time T₄, SPU4 may complete the processing of sub-space 112₄ and obtain the graphics data for the objects 102 of sub-space 112₇ and begin processing that data. Finally, at about time T₅, SPU2 may complete the processing of sub-space 112₂ and obtain the graphics data for the objects 102 of sub-space 112₈ and begin processing that data. This process continues until all of the objects 102 of the space 104 are processed in the given frame, e.g., at time T_{END}.

In accordance with at least one further aspect of the present invention, the methods and apparatus described above may be achieved utilizing suitable hardware, such as that illustrated in the figures. Such hardware may be implemented utilizing any of the known technologies, such as standard digital circuitry, any of the known processors that are operable to execute software and/or firmware programs, one or more programmable digital devices or systems, such as programmable read only memories (PROMs), programmable array logic devices (PALs), etc. Furthermore, although the apparatus illustrated in the figures are shown as being partitioned into certain functional blocks, such blocks may be implemented by way of separate circuitry and/or combined into one or more functional units. Still further, the various aspects of the invention may be implemented by way of software and/or firmware program(s) that may be stored on suitable storage medium or media (such as floppy disk(s), memory chip(s), etc.) for transportability and/or distribution.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method, comprising:
grouping objects within a three dimensional (3D) graphics space into a plurality of object sets, each object set being located in a respective sub-space within the 3D space;
computing final graphics data for each object of the object sets based on initial graphics data for each of the objects, where the respective computations for each of the object sets are performed using a respective one of a plurality of processors of a multi-processor system; and
repeating the above steps for each of a plurality of image frames using the final graphics data from a previous image frame as the initial graphics data for a current image frame.

2. The method of claim 1, wherein the graphics data for each object includes at least one of position data, force data, velocity data, color data, and mass data.

3. The method of claim 2, wherein the computation of final graphics data for a given object includes computing final position data for the object as a fimction of initial position data of the object and at least one of: an initial velocity of the object from the velocity data, an initial force on the object from the force data, and an initial mass of the object from the mass data.

4. The method of claim 2, wherein the computation of final graphics data for a given object includes computing whether the object collides with another object.

5. The method of claim 2, wherein the step of grouping the objects into the object sets within the sub-spaces of the 3D space includes re-grouping at least some of the objects when the computation of final graphics data indicates that one or more objects have final position data falling outside their initial sub-spaces.

6. The method of claim 1, further comprising: transforming at least some of the final graphics data into two dimensional (2D) data; and rendering the 2D data for display on a display screen.

7. The method of claim 1, wherein the processors are operable to perform single instruction multiple data (SIMD) computations.

8. The method of claim 1, further comprising:
storing the final graphics data for the objects in a system memory that is operatively coupled to the plurality of processors; and
grouping the final graphics data within the system memory in a manner that corresponds to the object sets and sub-spaces.

9. The method of claim 8, further comprising re-grouping the final graphics data within the system memory when the computation of final graphics data indicates that one or more objects have final position data falling outside their initial sub-spaces.

10. The method of claim 9, wherein:
the processors are operable to read/write data from/to the system memory in blocks, each block being a contiguous area in the system memory; and
the graphics data for each object includes at least one of position data, force data, velocity data, color data, and mass data.

11. The method of claim 10, wherein at least one of: (i) all of the position data are stored in a respective one or more contiguous blocks of memory; (ii) all of the force data are stored in a respective one or more contiguous blocks of memory; (iii) all of the velocity data are stored in a respective one or more contiguous blocks of memory; and (iv) all of the color data are stored in a respective one or more contiguous blocks of memory.

12. The method of claim 10, wherein at least one of:
all of the graphics data for a given object are stored in the same block of system memory;
all the graphics data for a plurality of objects are stored in the same block or contiguous blocks of system memory;
all the graphics data for a given object set are stored in the same block or contiguous blocks of system memory.

13. The method of claim 12, wherein all of the graphics data for a given object are stored sequentially within the same block of system memory.

14. The method of claim 10, wherein:
the processors are operable to perform single instruction multiple data (SIMD) computations, the number of multiple data computations being N; and
at least some of the graphics data for respective sets of N objects are stored sequentially within the same block in system memory.

15. The method of claim 14, wherein at least one of the position data, the force data, the velocity data, the color data, and the mass data for respective sets of N objects are stored sequentially within the same block in system memory.

16. The method of claim 8, further comprising using the processors to read and process the graphics data for the object sets of the sub-spaces from system memory as the processors become available.

17. The method of claim 1, wherein a size of one or more of the sub-spaces is determined as a function of processing capabilities of the processors.

18. The method of claim 17, wherein the processing capabilities include at least one of: a frame rate at which the processors are expected to compute the graphics data for the objects; speeds at which the processors can access the graphics data in memory; speeds at which the processors can compute the graphics data; and local memory size within each of the given processors.

19. A processing system, comprising:
a system memory operable to store graphics data for each of a plurality of objects within a three dimensional (3D) graphics space; and
a plurality of processors each operable to:
group the objects within the 3D graphics space into a plurality of object sets, each object set being located in a respective sub-space within the 3D space,
compute final graphics data for each object of the object sets based on initial graphics data for each of the objects, where the respective computations for each of the object sets are performed using a respective one of the plurality of processors, and
repeat the grouping and computing functions for each of a plurality of image frames using the final graphics data from a previous image frame as the initial graphics data for a current image frame.

20. The system of claim 19, wherein the graphics data for each object includes at least one of position data, force data, velocity data, color data, and mass data.

21. The system of claim 20, wherein the processors are further operable to compute the final position data for a given object as a function of initial position data of the object and at least one of: an initial velocity of the object from the velocity data, an initial force on the object from the force data, and an initial mass of the object from the mass data.

22. The system of claim 20, wherein the processors are further operable such that the computation of final graphics data for a given object includes computing whether the object collides with another object.

23. The system of claim 20, wherein the processors are further operable such that the grouping the objects into the object sets within the sub-spaces of the 3D space includes re-grouping at least some of the objects when the computation of final graphics data indicates that one or more objects have final position data falling outside their initial sub-spaces.

24. The system of claim 19, wherein the processors are further operable to transform at least some of the final graphics data into two dimensional (2D) data; and render the 2D data for display on a display screen.

25. The system of claim 19, wherein the processors are operable to perform single instruction multiple data (SIMD) computations.

26. The system of claim 19, wherein the processors are further operable to:
store the final graphics data for the objects in the system memory; and
group the final graphics data within the system memory in a manner that corresponds to the object sets and sub-spaces.

27. The system of claim 26, wherein the processors are further operable to re-group the final graphics data within the system memory when the computation of final graphics data indicates that one or more objects have final position data falling outside their initial sub-spaces.

28. The system of claim 27, wherein:
the processors are operable to read/write data from/to the system memory in blocks, each block being a contiguous area in the system memory; and
the graphics data for each object includes at least one of position data, force data, velocity data, color data, and mass data.

29. The system of claim 28, wherein at least one of: (i) all of the position data are stored in a respective one or more contiguous blocks of memory; (ii) all of the force data are stored in a respective one or more contiguous blocks of memory; (iii) all of the velocity data are stored in a respective one or more contiguous blocks of memory; and (iv) all of the color data are stored in a respective one or more contiguous blocks of memory.

30. The system of claim 28, wherein at least one of:
all of the graphics data for a given object are stored in the same block of system memory;
all the graphics data for a plurality of objects are stored in the same block or contiguous blocks of system memory;
all the graphics data for a given object set are stored in the same block or contiguous blocks of system memory.

31. The system of claim 30, wherein all of the graphics data for a given object are stored sequentially within the same block of system memory.

32. The system of claim 28, wherein:
the processors are operable to perform single instruction multiple data (SIMD) computations, the number of multiple data computations being N; and
at least some of the graphics data for respective sets of N objects are stored sequentially within the same block in system memory.

33. The system of claim 32, wherein at least one of the position data, the force data, the velocity data, the color data, and the mass data for respective sets of N objects are stored sequentially within the same block in system memory.

34. The system of claim 26, further comprising using the processors to read and process the graphics data for the object sets of the sub-spaces from system memory as the processors become available.

35. The system of claim 19, wherein a size of one or more of the sub-spaces is determined as a function of processing capabilities of the processors.

36. The system of claim 17, wherein the processing capabilities include at least one of: a frame rate at which the processors are expected to compute the graphics data for the objects; speeds at which the processors can access the graphics data in memory; speeds at which the processors can compute the graphics data; and local memory size within each of the given processors.

37. An apparatus, comprising: a plurality of processors, each connectable to a system memory for storing graphics data for each of a plurality of objects within a three dimensional (3D) graphics space, wherein the processors are each operable to: (i) group the objects within the 3D graphics space into a plurality of object sets, each object set being located in a respective sub-space within the 3D space, (ii) compute final graphics data for each object of the object sets based on initial graphics data for each of the objects, where the respective computations for each of the object sets are performed using a respective one of the plurality of processors, and (iii) repeat the grouping and computing functions for each of a plurality of image frames using the final graphics data from a previous image frame as the initial graphics data for a current image frame.

38. A storage medium containing software code operable to cause one or more of a plurality of processors, each connectable to a system memory for storing graphics data for each of a plurality of objects within a three dimensional (3D) graphics space, to execute actions, comprising:
grouping the objects within the 3D graphics space into a plurality of object sets, each object set being located in a respective sub-space within the 3D space;
computing final graphics data for each object of the object sets based on initial graphics data for each of the objects, where the respective computations for each of the object sets are performed using a respective one of the plurality of processors; and
repeating the grouping and computing functions for each of a plurality of image frames using the final graphics data from a previous image frame as the initial graphics data for a current image frame.
